(19) United States
(12) Patent Application Publication
(10) Pub. No.: US 2003/0137210 A1
(43) Pub. Date: Jul. 24, 2003

(54) Integrated commutator and slip-ring with sense magnet

(76) Inventors: Otway Archer Southall, Farmville, VA (US); Alvin Leon Farthing, Roseboro, NC (US); Dan L. Shull, Cameron, NC (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/346,925

(22) Filed: Jan. 17, 2003

Related U.S. Application Data
(63) Continuation-in-part of application No. 09/932,201, filed on Aug. 17, 2001.

(51) Int. Cl. H02K 1/00

(52) U.S. Cl. 310/232

(57) ABSTRACT

A motor slip-ring is equipped with a magnet for inclusion in a sensor assembly for detecting and diagnosing motor inefficiencies and problems as well as in adjusting motor parameters to impact motor operation. The slip-ring comprises a shell, an insulating core positioned adjacent the shell, and at least one magnet positioned adjacent the core. Magnetic sensors placed within the motor housing detect and read the flux lines emitted from the magnet on the slip-ring. The magnet is preferably chemically bonded with the slip-ring, thereby facilitating its retention in the motor housing, and is preferably manufactured from an electrically non-conductive material and therefore does not impact, in and of itself, the operation of the motor.

### RELATED APPLICATION DATA

This application is a continuation-in-part of U.S. Ser. No. 09/932,201, filed Aug. 17, 2001 and claims priority to PCT/US02/26126, filed Aug. 15, 2002.

### FIELD OF THE INVENTION

This invention relates to commutators and slip-rings equipped with magnets for use with electric motors and methods of manufacturing such commutators and slip-rings.

### BACKGROUND OF THE INVENTION

To diagnose problems and to gauge and control the operating characteristics of brush-type direct current (“DC”) or brush-type alternating current (“AC”) motors, motor manufacturers and users have resorted to a variety of sensing methods, including optical encoders (which can add cost to the motor) and estimations based upon back electromotive force (“EMF”) from the rotor (which are usually not entirely accurate).

Magnets have also been incorporated into the motor assembly to provide feedback on motor function. A magnet is typically mounted on the rotor shaft and coupled with a variable reluctance (“VR”) sensor or a Hall-Effect sensor. Such a sensor arrangement costs less than optical encoders and is more accurate than back EMF detection. Using conventional manufacturing methods, however, incorporation of a magnet into the motor assembly results in handling of additional components and addition of steps to the manufacturing process. Both of these factors increase the manufacturing costs of motors having motor function sensing capabilities.

In addition to increased motor costs, traditional methods of incorporating a sense magnet into the motor assembly, generally by gluing the magnet onto the rotor shaft or by pressing the magnet onto a knurl located on the rotor shaft, have proven ineffective to retain the magnet in the housing, thereby leading to failure of the sensing device. When the shaft rotates at high revolutions per minute (rpms), the glue bond oftentimes is insufficient to retain the magnet on the shaft. Alternatively, the magnet can disengage from the knurl during operation of the motor. The improperly-secured magnets can lead to the magnet breaking away from the shaft. The magnets are therefore unable to relay flux lines to the sensors and thereby facilitate the collection of information regarding motor function.

U.S. Pat. No. 6,400,050 to Naman et al. discloses detecting rotary motion of a motor using a magnet and a sensor. A magnet is embedded in the commutator core during the core injection-molding process. When the resin core is injection-molded onto the magnet, the molten resin is forced into and around surface features on the magnet, filling and surrounding imperfections, such as cavities and ridges, on the magnet surface and resulting in a mechanical bond between the magnet and the resin. The location of the magnet on the commutator as disclosed in Naman et al. can interfere with operation of the sensor and result in inaccurate results, however. For example, the magnet in Naman et al. is located on the commutator adjacent the motor windings and commutator tangs, which can obstruct the magnet and thereby impair the sensor's ability to read the magnetic field produced by the magnet. Moreover, location of the magnet in such close proximity to the armature and stator can result in the sensor inadvertently reading stray magnetic fields generated by the armature windings and the stator instead of the intended magnet.

U.S. Pat. No. 6,340,856 to Schiller discloses an electric motor equipped with a Hall sensor or Hall IC (a Hall sensor with an integrated circuit) and a multi-pole magnet, which cooperate to detect the revolutions per minute of the rotor. The magnet is press-fitted or molded onto a metal or plastic carrier ring which is then mounted on the rotor shaft. The magnet/carrier ring assembly is separate from the commutator.

### SUMMARY OF THE INVENTION

The present invention solves the problems of previous motor sensing assemblies by providing a commutator equipped with a magnet for use in detecting and diagnosing motor inefficiencies and problems as well as in adjusting motor parameters to impact motor operation. Magnetic sensors placed within the motor housing detect and read the flux lines emitted from the magnet on the commutator. The magnet is preferably a substantially continuous magnet ring that is integrally-formed with and chemically-bonded to the commutator, thereby facilitating its retention in the motor housing. The sense magnet is then magnetized with an array of magnetic North and South poles depending on the need of the application.

Because the magnet is preferably manufactured from a non-electrically conductive material, it does not impact, in and of itself, the operation of the motor. Rather, the output from the sensors of the magnitude and/or frequency of the magnetic poles can be used to determine operating characteristics of the motor (such as speed, angular position, acceleration, etc.) and thereby allow the user to detect and diagnose problems in the motor and adjust parameters (such as current) of the motor to impact its operation and performance.

Moreover, the preferable placement of the magnet on the commutator face opposite the tangs and windings (1) reduces interference between the magnet and the sensor by these structures; (2) distances the magnet from the armature and stator to reduce the risk of the sensor inadvertently sensing the fields produced by the armature and stator; and (3) allows placement of the sensor relative to the magnet to optimally balance the sensor position and the strength of the magnetic field produced by the magnet. Inclusion of a magnet in this way thereby transforms the commutator into a more powerful diagnostic and monitoring tool.

The present invention also includes incorporation of a magnet on a slip-ring (preferably, but not necessarily, on the end of the slip-ring) in a similar fashion to achieve the same benefits as described above with the commutator.

According to the present invention, in a commutator for a motor, the commutator includes at least one magnet integrally-formed with and chemically-bonded to the commutator.

According to the present invention, in a slip-ring for a motor, the slip-ring includes at least one magnet integrally-formed with and chemically-bonded to the slip-ring.

In a preferred embodiment of the present invention, the magnet is a substantially continuous magnet ring.

Also, according to a further embodiment of the present invention, a motor sensing assembly includes a commutator having a shell; an insulating core positioned adjacent the shell; and at least one magnet chemically-bonded to the core.

Also, according to a further embodiment of the present invention, a motor sensing assembly includes a slip-ring having a shell; an insulating core positioned adjacent the shell; and at least one magnet chemically-bonded to the core.

Again, according to the present invention, a method of manufacturing a commutator comprises providing a shell; providing a magnet mixture of a magnet powder and a resin; positioning the magnet mixture at least partially adjacent the shell; and positioning an electrically-insulative core in contact with the magnet mixture and the shell to chemically-bond with the magnet mixture.

Again, according to the present invention, a method of manufacturing a slip-ring comprises providing a shell; providing a magnet mixture of a magnet powder and a resin; positioning the magnet mixture at least partially adjacent the shell; and positioning an electrically-insulative core in contact with the magnet mixture and the shell to chemically-bond with the magnet mixture.

In a preferred method of the present invention, the magnet mixture is a pre-form.

Again, according to the present invention, a method of manufacturing a slip-ring comprises providing a shell; positioning a mixture of magnet powder and thermoplastic resin at least partially adjacent to and in contact with the shell to mechanically-interlock with the shell.

It is a feature of the present invention to improve the integrity of a motor function sensor assembly by integrally-forming the magnet of the assembly with the motor commutator.

It is a feature of the present invention to improve the integrity of a motor function sensor assembly by integrally-forming the magnet of the assembly with the motor slip-ring.

It is another feature of the present invention to obviate the need for and expense of additional mechanical retention means to retain the magnet of the motor function sensor assembly in the motor housing.

### BRIEF DESCRIPTION OF THE DRAWINGS

FIG. 1 is a cross-sectional view of one embodiment of the commutator according to the present invention.

FIG. 2 is a perspective view of the embodiment of FIG. 1.

FIG. 3 is a perspective view of another embodiment of the commutator of the present invention.

FIG. 4 is a perspective view of another embodiment of the commutator of the present invention.

FIG. 5 is a perspective view of one embodiment of the slip-ring according to the present invention.

FIG. 6 is another perspective view of the embodiment of the slip-ring of FIG. 5.

FIG. 7 is a cross-sectional view taken at line 7-7 of FIG. 5.

FIG. 8 is a perspective view of an alternative embodiment of the slip-ring according to the present invention.

FIG. 9 is another perspective view of the embodiment of the slip-ring of FIG. 8.

FIG. 10 is a cross-sectional view taken at line 10-10 of FIG. 7.

### DETAILED DESCRIPTION OF THE DRAWINGS

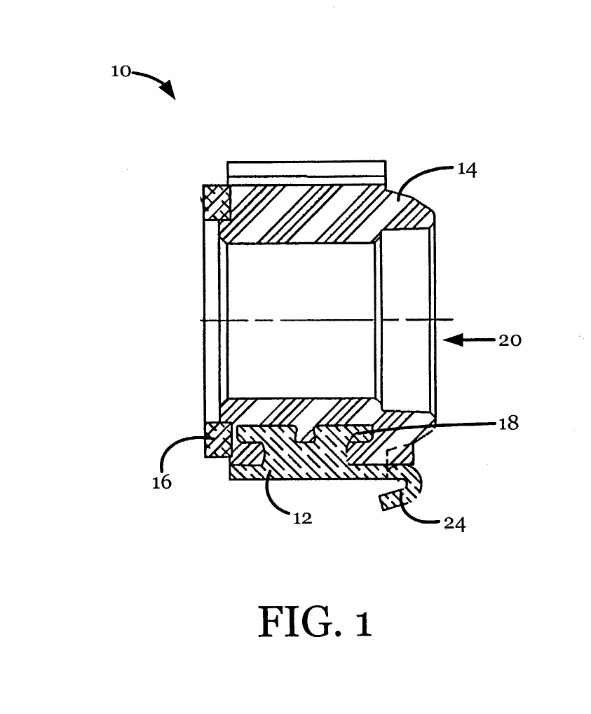

FIG. 1 provides a cross-sectional view of an embodiment of an exemplary commutator 10 according to the present invention. Note, however, that magnets may be incorporated into any type of commutator, and their use is not limited to use in only those commutators discussed and disclosed in the present application. For example, U.S. Pat. No. 5,491,373 to Cooper et al., the entirety of which is incorporated herein by reference, discloses a barrel-style commutator having multiple electrically-conductive copper segments arranged into a cylinder on the outer diameter of the non-conductive core to form the shell of the commutator. The motor brush interacts with the copper segments to supply power to the armature. U.S. Pat. Nos. 5,760,518 and 5,826,324 to Abe et al. (also incorporated herein in their entireties by this reference) disclose a face-style commutator having electrically-conductive graphite segments located on the face of the commutator for conducting electricity.

Alternatively, U.S. Pat. No. 6,236,136 (“'136 patent”) to Hockaday et al., the entirety of which is incorporated herein by reference, discloses both a face-style and a barrel-style commutator having carbon pre-forms located on the face or the barrel of the commutator, respectively. While, as with the commutator of Cooper et al., a metal shell forms the outer diameter of the commutator, the carbon pre-forms (not the metal shell as in Cooper et al.) are the principle conductors of electricity in the '136 patent.

The commutator 10 of FIG. 1 includes an outer electrically-conductive shell 12, tangs 24, an electrically-insulative core 14, and at least one magnet 16. The shell 12 may be made from copper or any suitable metal. While not necessary, at least one anchor 18 preferably extends radially inwardly from the shell 12.

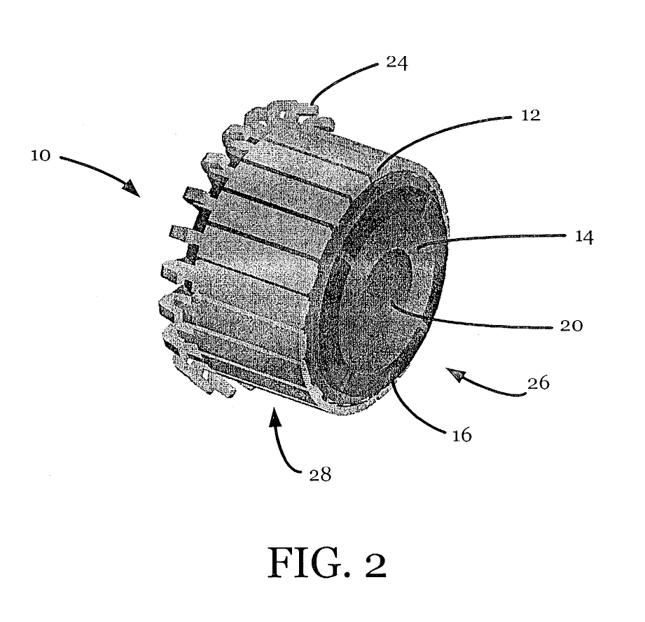

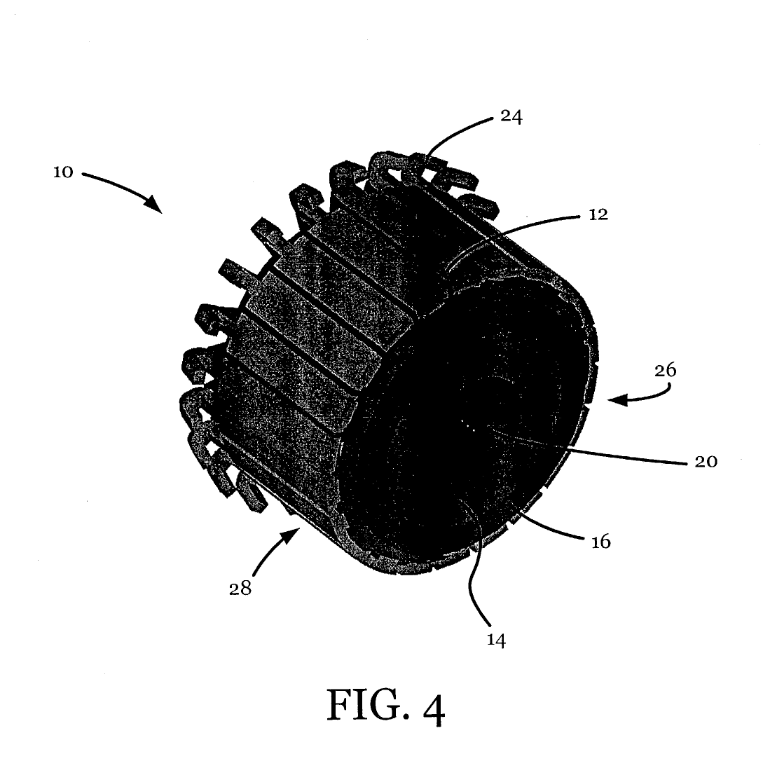

The magnet 16 is preferably, but does not have to be, formed before its incorporation into the assembly. The magnet 16 is preferably made from a so-called “green” pre-form mixture of magnet powder and thermo-set resin binder, which is subsequently heated and/or compressed and/or otherwise cured to form the final magnet. The magnet powder may be of any magnet material. Non-electrically conductive magnet materials, such as strontium ferrite (SrFe) or barium ferrite (BaFe), however, have proved especially useful in this application. While the magnet 16 may be formed using other techniques, such as by curing, it is preferably formed by compressing the powder mixture into a mold, which may be performed under no or minimal heat. While the magnet 16 may be molded into any shape, because commutators are typically cylindrical, a continuous magnet ring (as shown in FIG. 4) is preferable. The commutator 10 is not limited to a single magnet, however, but may be equipped with multiple magnets (as shown in FIG. 2). The magnet or magnets may be magnetized with an array of magnetic poles either on the outer diameter, the top face, or both.

The core 14 is made of electrically-insulative material, typically (although not necessarily) phenolic, and defines a central aperture 20 for receiving a spindle or shaft in use. The core 14 chemically-bonds to the magnet 16, as discussed below, to secure the magnet 16 in the commutator 10. Moreover, the core 14 also surrounds the anchor 18, thereby securing the core 14 in position relative to the shell 12.

The commutator 10 is manufactured using a method that relies on the commutator's 10 design and materials to impart stability to the assembly. In one exemplary manufacturing process, the magnet pre-form 16 and shell 12 are first positioned within the commutator mold. Note, however, that a pre-formed magnet need not be used. Instead of pre-forming the magnet mixture into the magnet, the mixture of magnet powder and thermoset resin could simply be poured directly into the mold. Regardless, after the magnet mixture (whether pre-formed into a magnet or in powder form) and shell 12 are positioned within the mold, the phenolic core 14 is injection-molded into the mold. The act of such molding embeds portions of the anchor 18 within the core 14, thereby securing its position relative to the shell 12.

Moreover, the molded core 14 also intimately contacts the already-placed magnet 16. The high pressures and temperatures used to mold the core 14 result in both a chemical and mechanical bond between the core 14 and magnet 16 at their interface. During molding, the resin in the core 14 cross-links with the resin in the magnet 16 to chemically bond the magnet 16 to the core 14. In this way, the magnet 16 ceases to be a separate component, but rather is integrally-formed with the commutator. Moreover, molding can also result in the mechanical interlock of features (i.e. protrusions and cavities not shown) on the adjoining surfaces of the core 14 and magnet 16 (or possibly created by at least slight deformation of either or both components during the molding process). This chemical bonding and mechanical interlock between the core 14 and magnet 16 functions to secure the magnet 16 within the shell 12 and integrally-form the magnet 16 with the commutator 10.

While the magnet may be positioned anywhere on the commutator, it is preferably located on the commutator face opposite the tangs and windings (as shown in FIGS. 1, 2, and 4) and away from the magnetic “noise” created by the motor windings.

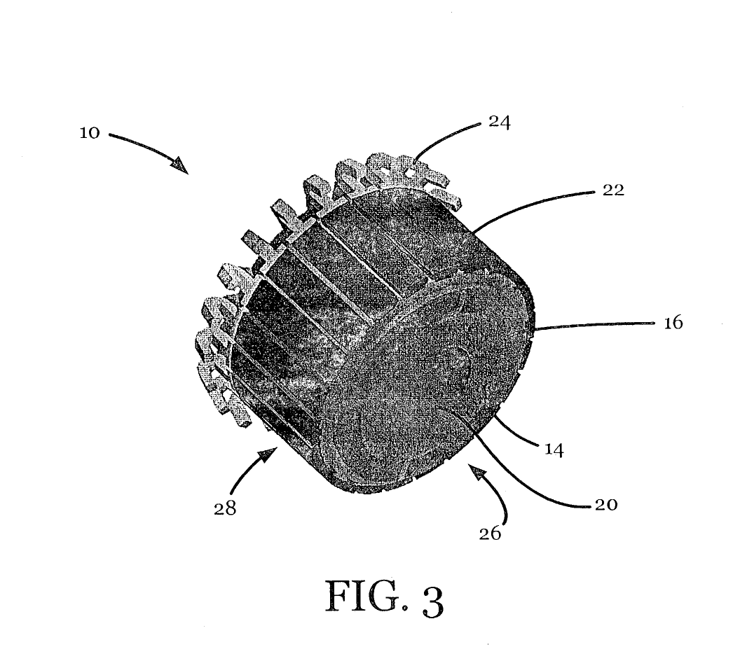

While, in the embodiments of FIGS. 1, 2, and 4, the magnet 16 is positioned on the face 26 of the commutator 10, the magnet may also be incorporated into a face-style commutator and positioned on the outer diameter of the commutator. Moreover, while the commutator 10 of FIGS. 1, 2, and 4 relies upon the metal shell 12 for electrical conductivity, the commutator 10 may also be manufactured in accordance with the '136 patent to include electrically-conductive pre-forms, preferably, but not necessarily, made from a carboneous material. If the carbon pre-forms are positioned on the face of the commutator, the magnet is preferably positioned on the barrel of the commutator. Alternatively, as shown in FIG. 3, if the carbon pre-forms 22 are positioned on the barrel 28 of the commutator 10, the magnet 16 is preferably positioned on the face 26 of the commutator 10.

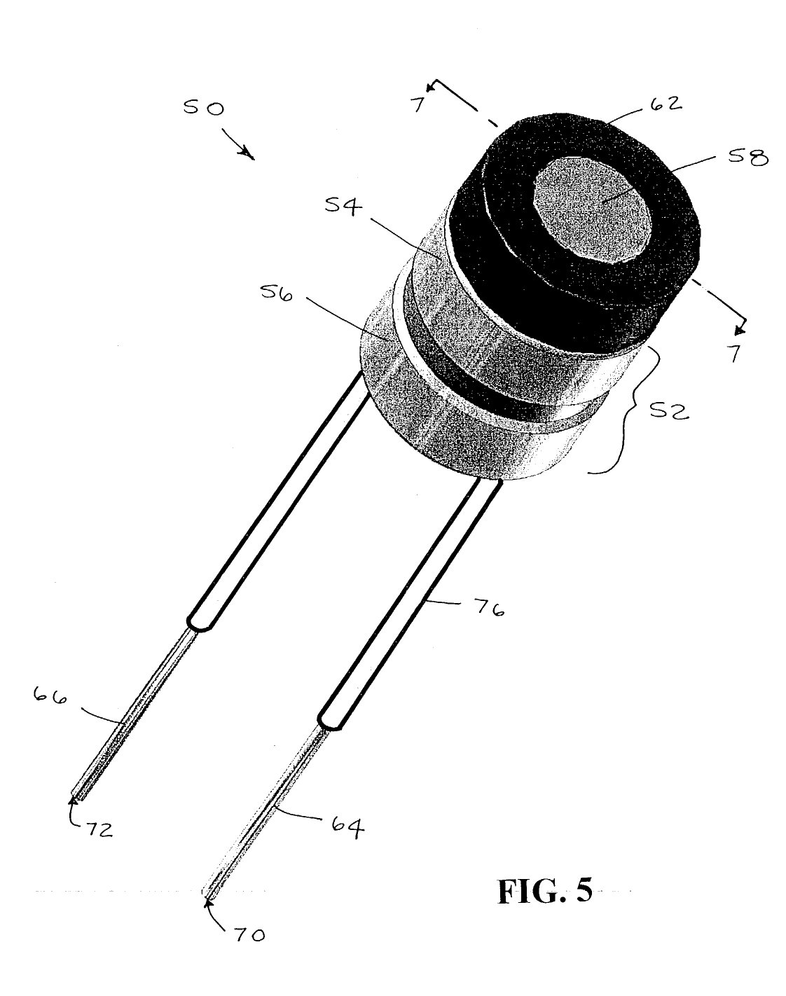

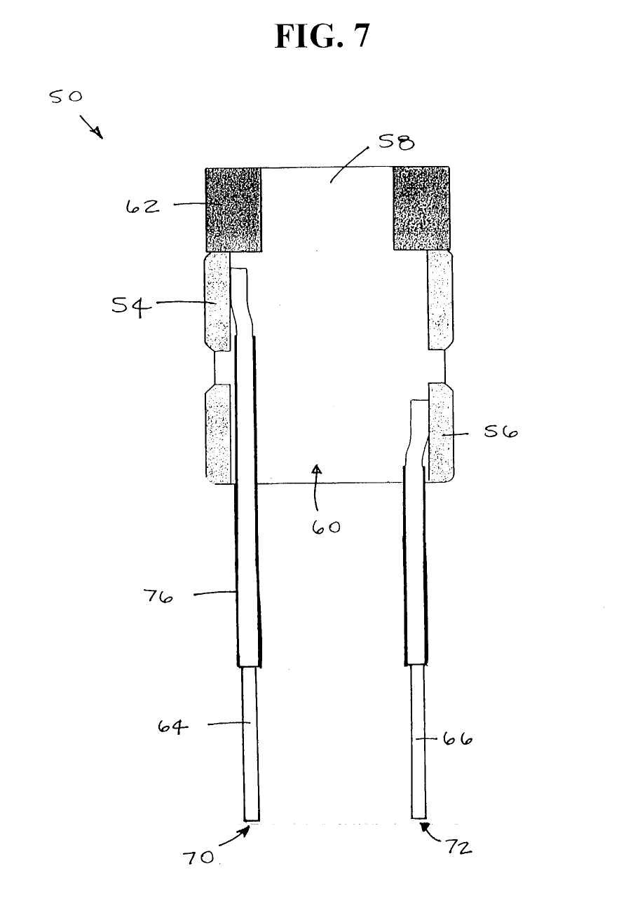

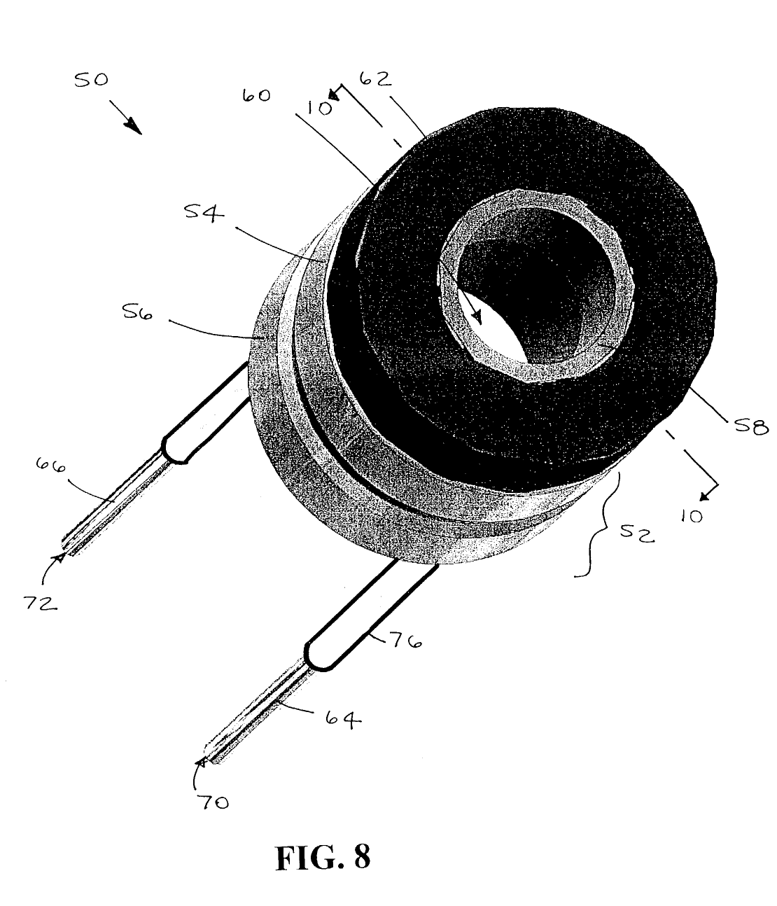

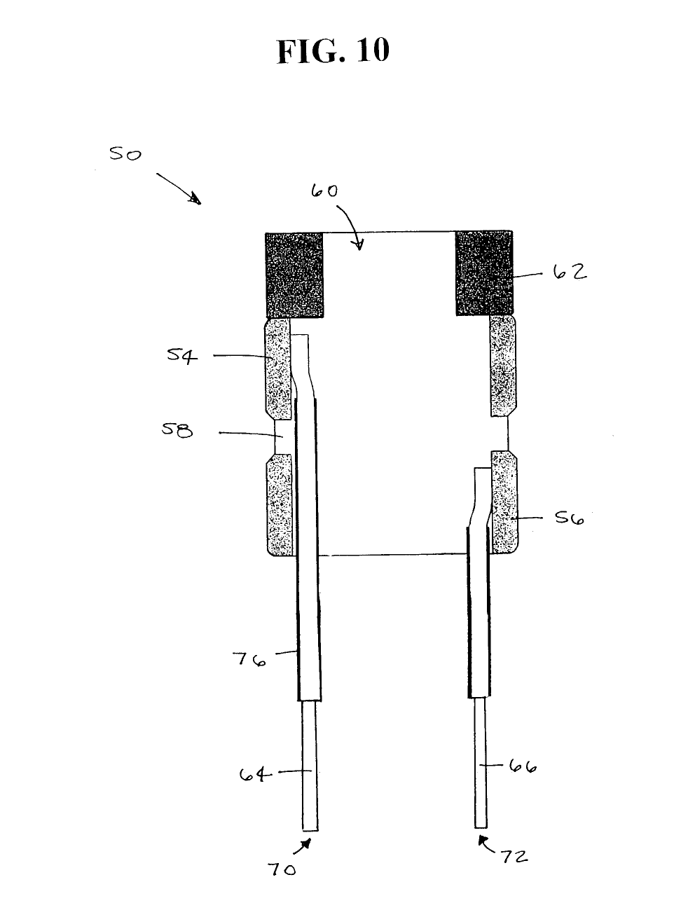

FIGS. 5-7 respectively provide two perspective views and a cross-sectional view of an embodiment of an exemplary slip-ring 50 according to this invention in which a magnet 62 is preferably integrally-formed with the slip-ring 50. Similarly, FIGS. 8-10 respectively provide two perspective views and a cross-sectional view of an alternative embodiment of an exemplary slip-ring 50 according to this invention in which a magnet 62 is preferably integrally-formed with the slip-ring 50. FIGS. 5-7 and FIGS. 8-10 use identical reference numbers to identify identical structure in each illustrated embodiment of the slip-ring. For ease of discussion and unless otherwise indicated, reference to FIGS. 5-7 has predominantly been made to describe the structure of one embodiment of the slip-ring of this invention. However, as described below, numerous alternative embodiments of the slip-ring exist and such reliance on FIGS. 5-7 is in no way intended to limit the scope of this invention.

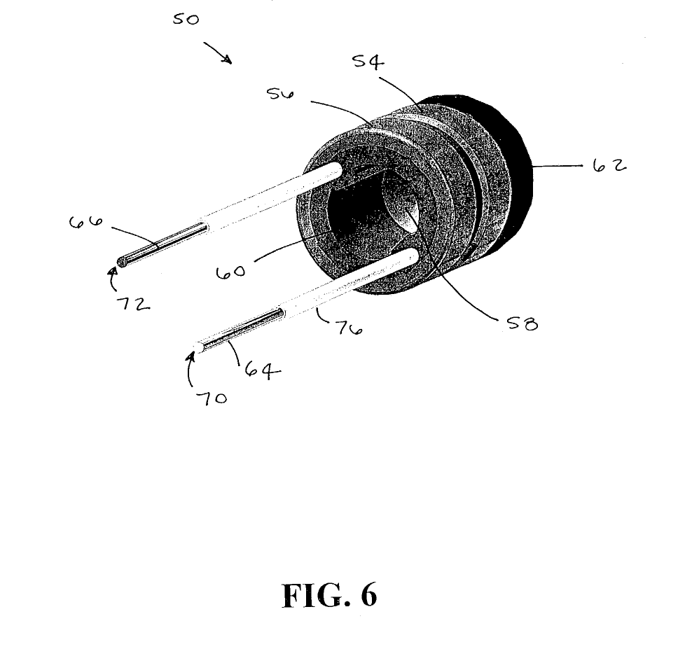

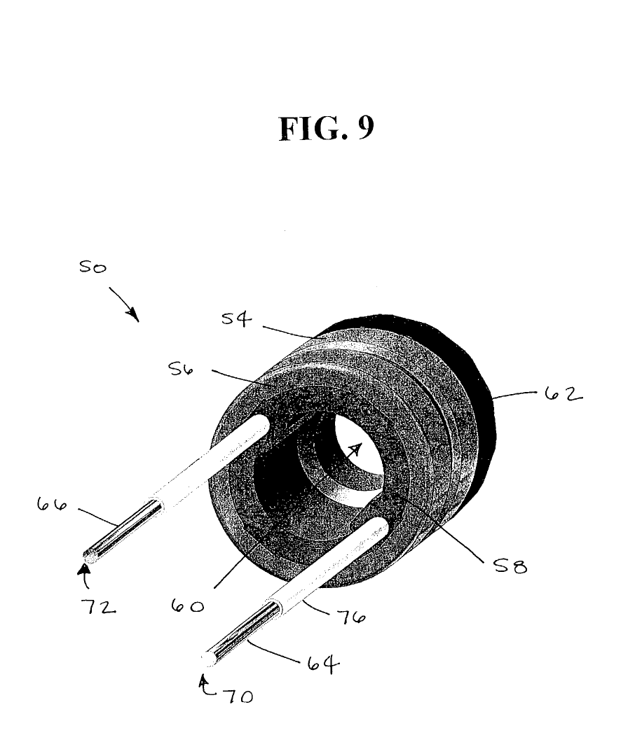

A slip-ring provides a path for current that can be used to power a rotating member or for data collection. One embodiment of the slip-ring 50 of this invention includes an electrically-conductive shell 52, preferably formed with continuous rings 54, 56 made from copper or any suitable metal, an electrically-insulative core 58 defining a central aperture 60 for mounting the slip-ring 50 on a spindle or shaft, and at least one multi-pole magnet 62 exposed on either or both of the end face and outer diameter wall of the slip-ring 50. The aperture 60 may extend partially through the slip-ring 50 (as shown in FIGS. 5 and 6) or entirely through the slip-ring 50 (as shown in FIGS. 8 and 9) depending on the application of the slip-ring. A wire lead 64, 66 (preferably, but not necessarily, insulated, such as by a sheath 76 of suitable insulating material, such as plastic) is secured to each respective shell ring 54, 56, one to transmit current to, and one to transmit current from, a rotating member (not shown). Rings 54, 56 are insulated from each other to provide a single path for current flow to and from the slip-ring.

In use, the free end 70, 72 of leads 64, 66 (respectively) are connected to a rotating member. A brush (not shown) rides on each shell ring 54, 56. One brush supplies current from a power supply to its associated ring. For ease of discussion, shell ring 54 is assumed to be the ring to which current is supplied by its associated brush. However, one skilled in the art will understand that current may be supplied to either ring 54 or 56. The current supplied in this case to ring 54 is, in turn, transmitted to the rotating member via lead 64 connected to shell ring 54 to effectuate rotation of the member. Current exiting the rotating member is transmitted back to the slip-ring 50 via lead 66. The brush riding along shell ring 56 transmits the current from the rotating member (via lead 66 and ring 56) back to the power supply (not shown) to thereby complete the current path. Again, however, one skilled in the art will recognize that shell ring 56 with lead 66 could deliver current from the slip-ring 50 to the rotating member and shell ring 54 with lead 64 could transmit the current from the rotating member back to the slip-ring 50.

While the shell 52, magnet 62, and core 58 of the slip-ring 50 may be assembled such as by welding or gluing the components together, the slip-ring 50 is preferably manufactured using a method that obviates the need for such retention means, but rather relies on the slip-ring's design and materials to impart stability to the assembly. Similar to manufacture of the commutator, the slip-ring 50 may be manufactured using a “green” pre-form of magnet powder and thermo-set resin binder, as described above. While FIGS. 5-10 illustrate a continuous magnet ring 62, the magnet may also be a solid disc (not shown). Moreover, the slip-ring 50 may be equipped with multiple magnets and is not limited to a single magnet. The magnet or magnets may be magnetized with an array of magnetic poles on the outer diameter, the top face, or both.

In one possible manufacturing process, the magnet pre-form 62 and shell 52 (with associated leads 64, 66) are first positioned within the slip-ring mold. Note, however, that a pre-formed magnet need not be used. Instead of pre-forming the magnet powder mixture into the magnet, the powder mixture could simply be poured directly into the mold. Regardless, after the magnet mixture (whether pre-formed into a magnet or in powder form) and shell 52 are positioned within the mold, the core 58, preferably comprising an electrically-insulative material such as a thermoset resin, is injection-molded into the mold. The act of such molding embeds portions of the leads 64, 66 within the core 58, thereby securing its position relative to the shell 52.

Moreover, the molded core 58 intimately contacts the already-placed magnet 62. The high pressures and temperatures used to mold the core 58 result in both a chemical and mechanical bond between the core 58 and the magnet 62 at their interface. During molding, the thermoset resin in the core 58 cross-links with the thermoset resin in the magnet 62 to chemically bond the magnet 62 to the core 58. In this way, the magnet 62 ceases to be a separate component, but rather is integrally-formed with the slip-ring 50. Moreover, molding can also result in the mechanical interlock of features (i.e., protrusions and cavities not shown) on the adjoining surfaces of the core 58 and magnet 62 (or possibly created by at least slight deformation of either or both components during the molding process). This chemical bonding and mechanical interlock between the core 58 and magnet 62 functions to secure the magnet 62 within the shell 52 and integrally-form the magnet 62 with the slip-ring 50.

In an alternative embodiment of the slip-ring (not shown), the magnet and core are not two distinct components. Rather, both are formed of a magnet powder and thermoplastic resin binder. During manufacture of this embodiment, the shell (with associated leads) is first positioned in the slip-ring mold. The magnet/thermoplastic material (the “magnet core”) is then injection-molded into the mold. The act of such molding embeds portions of the leads within the magnet core, thereby securing its position relative to the shell.

Moreover, the high pressures and temperatures used to mold the magnet core into the shell result in a mechanical bond between the magnet core and the shell at their interface. During molding, features (i.e., protrusions and cavities not shown) on the adjoining surfaces of the magnet core and shell (or possibly created by at least slight deformation of either or both components during the molding process) mechanically interlock, which functions further to secure the magnet core within the shell and integrally-form the magnet with the slip-ring. After formation, any portion of the magnet core (but preferably the exposed outer diameter and top face) may be magnetized with an array of magnetic poles.

Sensors may then be used in combination with the commutator 10 or slip-ring 50 of the present invention to detect and read the flux emitted from the magnet 16 or 62 on the commutator 10 or slip-ring 50, respectively. While any sensor capable of detecting and reading flux may be used, magnetic sensors, such as Hall-Effect sensors, VR sensors, or inductive sensors are particularly well-suited in this application. Persons skilled in the relevant art will understand how to position and mount the sensors on the motor housing to read the flux lines emitted from the magnet. Because the magnets 16 and 62 are preferably of a non-electrically conductive material, they do not impact, in and of themselves, the operation of the motor. Rather the output from the sensors can be used to determine operating characteristics of the motor (such as speed, angular position, acceleration, etc.) and thereby allow the user to detect and diagnose problems in the motor and adjust parameters (such as current) of the motor to impact its operation and performance.

The foregoing is provided for the purpose of illustrating, explaining and describing embodiments of the present invention. Further modifications and adaptations to these embodiments will be apparent to those skilled in the art and may be made without departing from the spirit of the invention or the scope of the following claims.

We claim:

1. A slip-ring comprising:
a. a shell comprising at least two continuous rings, wherein the at least two continuous rings are insulated from each other;
b. at least two leads for transmitting current, wherein each of the at least two leads is secured to one of the at least two continuous rings;
c. an insulating core positioned adjacent the shell; and
d. at least one magnet positioned adjacent the core.

2. The slip-ring of claim 1, wherein the shell comprises copper.

3. The slip-ring of claim 1, wherein the core comprises electrically-insulative material.

4. The slip-ring of claim 3, wherein the core comprises a thermoset resin.

5. The slip-ring of claim 1, wherein the at least one magnet is chemically-bonded to the core.

6. The slip-ring of claim 1, wherein the at least one magnet is a substantially continuous ring.

7. The slip-ring of claim 1, wherein the magnet is exposed on an end face of the slip-ring.

8. The slip-ring of claim 1, wherein the magnet is at least partially exposed on an outer diameter wall of the slip-ring.

9. The slip-ring of claim 1, wherein the magnet comprises electrically nonconductive material.

10. The slip-ring of claim 1, wherein the magnet comprises a magnetic powder and a resin.

11. The slip-ring of claim 10, wherein the resin comprises a thermoset resin.

12. The slip-ring of claim 10, wherein the magnetic powder comprises strontium ferrite.

13. The slip-ring of claim 10, wherein the magnetic powder comprises barium ferrite.

14. A sensing assembly comprising the slip-ring of claim 1 and further comprising a sensor.

15. The sensing assembly of claim 14, wherein the sensor comprises a variable reluctance sensor.

16. The sensing assembly of claim 14, wherein the sensor comprises a Hall-Effect sensor.

17. The sensing assembly of claim 14, wherein the sensor comprises an inductive sensor.

18. A method of manufacturing a slip-ring comprising:
a. providing a shell comprising at least two continuous rings insulated from each other, the shell having at least two leads for transmitting current, wherein each of the at least two leads is secured to one of the at least two continuous rings;
b. providing a magnet;
c. positioning at least a portion of the magnet adjacent the shell; and
d. molding an electrically-insulative core in contact with the magnet and the shell.

19. The method of claim 18, wherein the core chemically bonds with the magnet during molding.

20. The method of claim 18, wherein the magnet is a substantially continuous ring.

21. The method of claim 18, wherein providing a magnet comprises mixing a magnet powder and a resin to form a powder mixture and compressing the powder mixture to form the magnet.

22. The method of claim 18, further comprising curing the core and magnet together.

23. The method of claim 18, wherein molding the core further comprises mechanically interlocking the core and the magnet.

24. A slip-ring comprising:
a. a shell comprising at least two continuous rings, wherein the at least two continuous rings are insulated from each other;
b. at least two leads for transmitting current, wherein each of the at least two leads is secured to one of the at least two continuous rings; and
c. a magnet core positioned adjacent the shell, wherein the magnet core comprises a magnet powder and a resin.

25. The slip-ring of claim 24, wherein the resin comprises a thermoplastic resin.

26. A method of manufacturing a slip-ring comprising:
a. providing a shell comprising at least two continuous rings insulated from each other, the shell having at least two leads for transmitting current, wherein each of the at least two leads is secured to one of the at least two continuous rings; and
b. molding a magnet core comprising a magnet powder and a resin in contact with the shell.

27. The method of claim 26, wherein the resin comprises a thermoplastic resin.

28. The method of claim 26, wherein molding the magnet core further comprises mechanically interlocking the magnet core and the shell.

29. The method of claim 26, wherein molding the magnet core further comprises embedding at least a portion of at least one of the at least two leads within the magnet core.
